(19) United States
(12) Patent Application Publication
(10) Pub. No.: US 2005/0212238 A1
(43) Pub. Date: Sep. 29, 2005

(54) Portable work table attachment system for a wheelbarrow and method

(76) Inventor: Francis E. Conley, Issaquah, WA (US)

Correspondence Address: DONNA J. THIES, 790 IDYLWOOD DR SW, ISSAQUAH, WA, 98027, US

(21) Appl. No.: 11/065,680

(22) Filed: Feb. 24, 2005

Related U.S. Application Data
(60) Provisional application No. 60/548,256, filed on Feb. 27, 2004.

(51) Int. Cl. B62B 1/00

(52) U.S. Cl. 280/47.32

(57) ABSTRACT

A portable work table attachment system for a wheelbarrow that comprises in part an attachment for a wheelbarrow that forms a portable work table with a large article holding opening and article or accessory holding pockets positioned thereon. The opening has a flat door so when the door is closed the upper surface of the attachment remains flat. The upper surface has a lip around its outside perimeter to keep articles from rolling off. A retainer on the underside of the attachment is positioned outside the outer periphery of the hopper to hold the attachment in place. An adjustable foot, in the form of a leveler serves to level the top rim of the hopper when the wheelbarrow is sitting on level ground. A stabilizer/leveler is provided that stabilizes and levels the top rim of the hopper when the wheelbarrow sits on level ground. Indicia is included on the upper surface of the attachment to assist the user. An attacher allows for the attachment to be attached to a storage wall when the unit is not in use. A method of providing a portable work table attachment is also provided.

Applicant hereby claims priority of provisional patent application 60/548,256 filed on Feb. 27, 2004.

### BACKGROUND OF THE INVENTION

In the area of tradesmen, do-it-yourself home improvement, or electricians, people having large properties to manage, or others, it would be particularly helpful to have a portable work table that would easily transport articles across a work area. For example, if a user were a carpenter, it would be very helpful to have a means of transporting tools, extension cords, nails, screws and the like, without carrying the items. Another example would be transporting plants and supplies in a garden area, or an electrician transporting wire and electrical components as he does his electrical work, but these are only examples and there would be any number of other applications where a portable work table would be particularly helpful.

U.S. Pat. No. 1,769,271 to Parsons discloses a wheelbarrow attachment used to increase the carrying capacity of a wheelbarrow.

U.S. Pat. No. 5,415,421 to Godwin discloses a tray device for wheelbarrows whereby a tray is formed across the handles of a wheelbarrow.

U.S. Pat. No. 6,193,265 to Yemini discloses a wheelbarrow with additional article carrying means along the outside of the wheelbarrow.

U.S. Pat. No. 6,547,309 to Franklin et al discloses a securing device for the contents of a wheelbarrow which is in the form of flexible paneling.

### SUMMARY OF THE INVENTION

In order to overcome problems inherent in the prior art, there has been devised by the present invention a portable work table attachment system for a wheelbarrow that comprises in part an attachment for a wheelbarrow that forms a portable work table with a large article holding opening and article or accessory holding pockets positioned thereon. The portable work table attachment system for a wheelbarrow includes in fist preferred embodiment a generally rectangular tabletop member having a flat upper surface with a lip around the outside perimeter to prevent articles from rolling off of the upper surface. An embodiment is included whereby the sides and top and bottom of the tabletop member overlap the sides and top and bottom of the hopper of the wheelbarrow. Another embodiment is included whereby the sides of the tabletop member are proximate with the sides of the hopper of the wheelbarrow. And yet another embodiment is included whereby the top and bottom and sides of the tabletop member are proximate with the top and bottom and sides of the hopper of the wheelbarrow. On the lower surface of the tabletop member there are two horizontal guides that are adapted to fit outside the outer periphery of the front and back of the hopper or containing portion of the wheelbarrow. The two horizontal guides are separated by and attached to two vertical strips also adapted to fit the outer periphery just outside of the two sides of the hopper or containing portion of the wheelbarrow. The guides and strips form a retainer that keeps the portable work table attachment removably positioned securely atop the upper rim of the wheelbarrow. The retainer keeps the portable work table attachment from moving around in its position atop the wheelbarrow. The retainer can be in any form that accomplishes this objective and can be fixedly or adjustably attached to the lower surface of the portable work table attachment. Also, fixedly attached to the lower surface of the portable work table attachment are clips or blocks that are designed to snugly hold the table top attachment to keep it from sliding around the top of the wheelbarrow. Proximate to the guides and strips that are near the back of the hopper and on the upper surface of the rectangular tabletop, there is positioned a door that opens to form a containing orifice having the floor of the hopper as its floor and the sides of the orifice are the sides of the wheelbarrow hopper. The orifice can be in any desirable configuration. The purpose of the orifice is to allow access to the wheelbarrow hopper without having to remove the tabletop. When the door is closed the upper surface of the tabletop remains flat. When the door is open the user can move useful articles through the orifice. The orifice can form an opening large enough to pass large tools through. Also, it is large enough for the diameter of a five gallon can of paint to pass through, but the orifice will also allow many other objects to pass through it to be stored in the hopper portion of the wheelbarrow. The present portable work table attachment system for a wheelbarrow also includes an adjustable foot that forms a leveler that is attached to the feet of the wheelbarrow to level the tabletop surface. This leveler can also be in any desirable configuration. The leveler is designed to raise the back end of the wheelbarrow so it makes the top rim of the hopper sit level when the wheelbarrow is sitting on level ground. The leveler raises the legs or back end of the wheelbarrow to make the hopper level when sitting on level ground. In a second preferred embodiment a stabilizer/leveler is used which has two purposes: first, to raise the legs or back end of the wheelbarrow to make the hopper level when sitting on level ground, and second, to make the wheelbarrow more stable, to prevent it from tipping sideways, by increasing the sideways reach of the legs when the second preferred embodiment of stabilizer/leveler is used.

The tabletop can also include indicia on the upper surface thereof, which may include among other things, a measuring grid, conversion tables or the like. Stretchable cording is attached between the tabletop and the extension of the handles to hold the tabletop to the wheelbarrow at each side of the wheelbarrow. The portable work table attachment system for a wheelbarrow also includes a plurality of accessory holding pockets that are easy off and easy on, that are positioned around the outer periphery of the portable work table attachment for holding useful items where it would be desirable to keep the items off the upper surface of the tabletop member. The accessory holding pockets can also be taken off the wheelbarrow table attachment system and used on a stationary work bench.

The portable work table attachment system for a wheelbarrow also comprises an attacher for attaching the tabletop member conveniently to a wall for storage. The attacher includes two upper slides that capture the table tight to the wall and can then be locked in place, and two lower brackets placed at a height on the wall whereby when the wheelbarrow with the tabletop attached is pushed up against the wall, front end first, the two lower brackets catch and capture the front end of the table top member as it is lifted and pivoted up and off of the wheelbarrow and swung into the locked position against the two upper slides.

### BRIEF DESCRIPTION OF THE DRAWINGS

FIG. 1 is a three dimensional view of the portable table attachment system for a wheelbarrow of the present invention shown positioned atop a wheelbarrow wherein the door is open and showing the present invention with tools and the like positioned in the orifice formed when the door in the tabletop member is open and showing some articles placed on the upper surface of the wheelbarrow table attachment.

FIG. 2 is a three dimensional view of the portable work table attachment system for a wheelbarrow of the present invention shown positioned atop a wheelbarrow showing how the door in the tabletop member can be easily opened or closed to return the upper surface of the tabletop member to a flat surface.

FIG. 3 is a three dimensional view of the portable work table attachment system for a wheelbarrow table of the present invention wherein the door is closed.

FIG. 4 is a bottom view of the portable work table attachment system for a wheelbarrow of the present invention.

FIG. 5 is a top view of the portable work table attachment system for a wheelbarrow of the present invention showing indicia on the top surface of the tabletop member such as a measuring grid, conversion tables, or the like.

FIG. 6 is a side view showing how a wheelbarrow is normally situated on level ground with the back of the hopper sloped downward from the front of the hopper.

FIG. 7 is a side view of the portable work table attachment system for a wheelbarrow of the present invention showing the tabletop leveled off when the wheelbarrow is situated on level ground, by means of the first preferred embodiment of leveler of the present invention.

FIG. 8 is a three dimensional view of the portable work table attachment system for a wheelbarrow of the present invention showing the tabletop leveled off when the wheelbarrow is situated on level ground, by means of a second preferred embodiment of leveler.

FIG. 9 is a side view of the portable work table attachment system for a wheelbarrow of the present invention showing how the back legs of the wheelbarrow are raised to level the top rim of the wheelbarrow, by means of the second preferred embodiment of stabilizer/leveler, as seen in FIG. 8.

FIG. 10 is a side view of the portable work table attachment system for a wheelbarrow of the present invention showing the easy off nature of the accessory holding pockets.

FIG. 11 is a side view of the portable work table attachment system for a wheelbarrow of the present invention showing the easy on nature of the accessory holding pockets.

FIG. 12 is a side view of the portable work table attachment system for a wheelbarrow of the present invention positioned atop a wheelbarrow with a plurality of accessory holding pockets in place.

FIG. 13 is a side view of the portable work table attachment system for a wheelbarrow of the present invention showing how a spring loaded or hand tightened latch can be used to attach the tabletop to the rim of a wheelbarrow.

FIG. 14 is a side view of the portable work table attachment system for a wheelbarrow of the present invention showing further how the spring loaded or hand tightened latch of FIG. 11 can be used to attach the tabletop to the top rim of a wheelbarrow.

FIG. 15 is a side view similar to FIG. 14 of the portable work table attachment system for a wheelbarrow of the present invention showing a cut out block attached to the bottom of the tabletop member that slips around the rim of the wheelbarrow on one side of the wheelbarrow and the spring loaded or hand tightened latch of FIG. 11 can be used to attach the tabletop to the top rim of a wheelbarrow on the other side of the wheelbarrow.

FIG. 16 is a side elevation view showing the portable work table attachment system for a wheelbarrow of the present invention and showing stretchable cording attached between the tabletop and the extension of the handles to hold the tabletop to the wheelbarrow at each side of the wheelbarrow.

FIG. 17 is a three dimensional view of a second preferred embodiment of the portable table attachment for a wheelbarrow of the present invention shown with the door open and showing a tabletop that is adapted to fit in close proximity to the top rim of the hopper of a wheelbarrow.

FIG. 18 is a side view of the portable work table attachment system for a wheelbarrow of the present invention as seen in FIG. 17 wherein a cut out block is attached to the bottom of the tabletop member to attach the tabletop member around the top rim of the wheelbarrow.

FIG. 19 is a side view of the portable work table attachment system for a wheelbarrow showing how the tabletop would be positioned to proceed to attach the tabletop member to the wall.

FIG. 20 is a front view of the attacher of the portable work table attachment system for a wheelbarrow as it would be positioned on a wall for holding the tabletop when the wheelbarrow table attachment system is not in use.

FIG. 21 is a side view of the portable work table attachment system for a wheelbarrow showing how the wheelbarrow table attachment system has been turned upward to place the tabletop against the appropriate part of the attacher for attaching the tabletop to a wall.

FIG. 22 is a front view of the attacher of the portable work table attachment system for a wheelbarrow after the tabletop has been attached to a wall using the attacher.

### DESCRIPTION OF THE PREFERRED EMBODIMENT

Referring now to the drawings in general, and in particular to FIG. 1, there is shown a three dimensional view of the portable work table attachment system for a wheelbarrow of the present invention shown positioned atop a wheelbarrow. The portable work table attachment system for a wheelbarrow is shown generally by the number 10. It can be seen in FIG. 1 that the portable work table attachment system for a wheelbarrow 10 comprises in part a wheelbarrow table attachment 12 that, in a first preferred embodiment, includes a generally rectangular tabletop member 14 having a flat upper surface 16 with a lip 18 around the outside perimeter 20 so that articles will not easily slip off the upper surface 22 of the tabletop member 14.

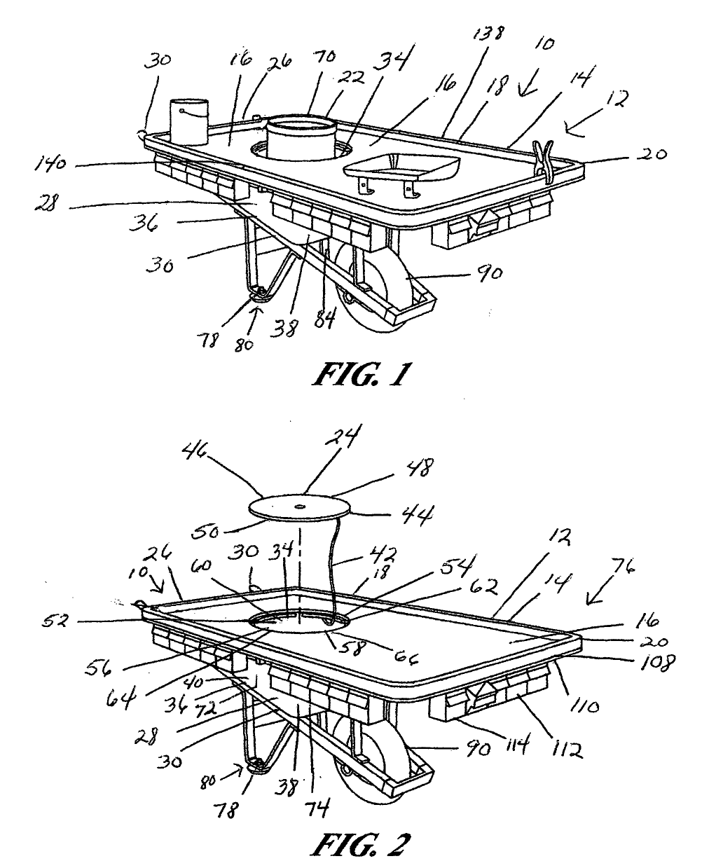

Referring now to FIG. 2 of the drawings there is shown a three dimensional view of the wheelbarrow table attachment system 10 shown positioned in its position atop a wheelbarrow showing how the door 24 in the tabletop member 14 can be easily opened or closed to return the upper surface 16 of the tabletop member 14 to a flat surface.

As seen in FIG. 2, the tabletop member 14 has a door 24 positioned therein, that is shown in the open position in FIGS. 1 and 2. The door 24 is positioned near the back 26 of the wheelbarrow 28, closest to the handle portion 30 of the wheelbarrow 28.

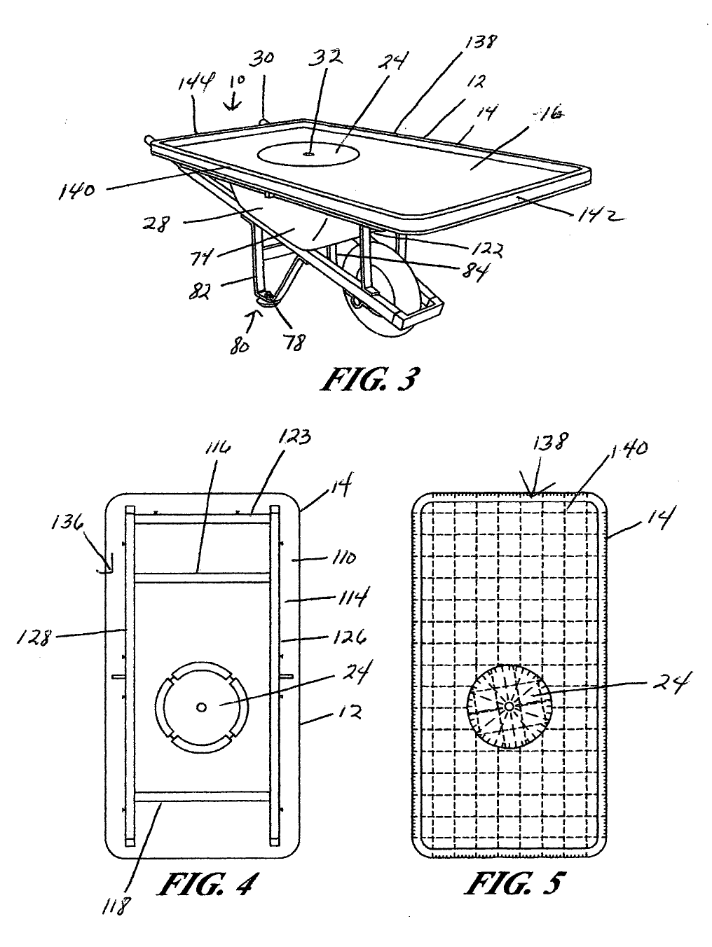

FIG. 3 is a three dimensional view of the wheelbarrow table attachment system 10 of the present invention when the door 24 is closed. When the door 24 is closed as it is in FIG. 3, it can be seen that a lifting opening hole 32 is used to open the door 24 and when the door 24 is closed it sits in flat within the upper surface 16 of the table top member 14, so as to keep the upper surface 16 of the tabletop member 14 flat. The door 24 can easily be opened by positioning a user's finger in the opening 32 in the door 24 and pulling upward. When the door 24 is open as seen in FIGS. 1 and 2, there is an orifice 34, with the floor 36 of the hopper portion 38 of the wheelbarrow 28 forming the floor 40 of the orifice 34, as seen most clearly in FIG. 2. The door 24 shown is circular, but it is within the spirit and scope of the present invention, to have the door in any useful shape. One reason for a circular door 24 is to provide a useful outline and support for a paint can 22, but the door 24 can also be of any desired shape. It can be seen in FIG. 2 that the door 24 has attached thereto a tether 42, so that when the door 24 is open and not in use, the door 24 can be dropped inside the orifice 34 and out of the way of the user. The door 24 has a top 44, a bottom 46 and two sides 48 and 50 that when the door 24 is open, leave an opening 52 in the tabletop member 14 that has corresponding sides 54 and 56 and a top 58 and bottom 60. The sides 62 and 64 of the orifice 34 are defined by the sides 54 and 56 of the opening 52. And the top 66 and bottom 68 of the orifice 34 are defined by the top 58 and bottom 60 of the opening 52. The orifice 38 forms the opening 52 that is adapted to receive large items and tools 70 within that portion 72 of the hopper 74 beneath the opening 52, as seen in FIG. 2, making the tabletop attachment of the present invention adaptable as a portable work table 76 for indoor and outdoor projects, but the present invention is, in no way, to be limited to these applications. The orifice 34 and the tabletop member 14 would also hold plants and accessories for gardens among many other applications.

The present portable work table attachment system for a wheelbarrow 12 also includes an adjustable foot 78 that forms a first preferred embodiment of a leveler 80 as seen most clearly in FIG. 7. The leveler 80 is attached to each rear leg 82 and 84 of the wheelbarrow 28 by means of a winged nut 85 positioned through a hole 86 in the rear legs 82 and 84 of the wheelbarrow 28. There is one leveler 80 attached to each rear leg 82 and 84 of the wheelbarrow 28. Only one leveler 80 shows attached to rear leg 82 in FIG. 7, but there is another similar leveler 80 attached to the other rear leg 84, as seen most clearly in FIG. 3. The purpose of the levelers 80 is to level the tabletop member 14 so it makes the top rim 87 of the hopper 74 level when the wheelbarrow 28 is sitting on level ground, as seen most clearly in FIG. 7. The height of the levelers 80 is adjustable and adapted to raise the legs 82 and 84 at the back 88 of the wheelbarrow 28 to a position level with the front wheel 90 position. The levelers 80 have the dual purposes of raising the rear legs 82 and 84 at the back 88 of the wheelbarrow 28 to make the hopper 74 level when the wheelbarrow 28 is sitting on level ground.

Included in the present wheelbarrow table attachment system 10, there are also two pieces of stretchable cording, only one piece of stretchable cording 92 shows in FIG. 16, but there is a similar piece of cording on the opposite side 94 of the wheelbarrow 28, the stretchable cording 92 each having a first end 96 and a second end 98 with hooks 100 at each end 96 and 98. The stretchable cording 92 is attached at one end 96 by the hook 100 to the underside 102 of tabletop member 14 and at its second end 98 by another similar hook 100 to the extended handle portion 106 of the wheelbarrow 28. The stretchable cording 92 serves to hold the tabletop member 14 tightly to the top rim 87 of the hopper 74, as seen most clearly in FIG. 1. When not in use, the stretchable cording 92 is attached to the hook 101, as seen in phantom on the side 107 of the wheelbarrow 28, so that the tabletop member 14 can be removed from the wheelbarrow 28.

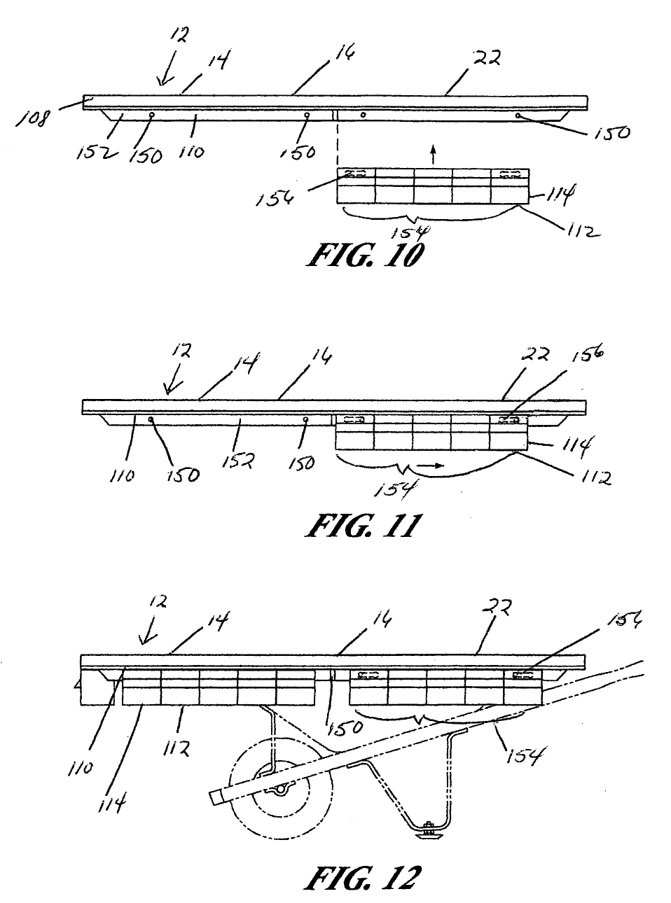

Positioned around the outer periphery 108 of the wheelbarrow table attachment 12 and removably attached around the periphery of the underside 110 of the tabletop member 14 are a plurality of accessory holding pockets 112, as seen most clearly in FIGS. 2, 10, 11 and 12. The accessory holding pockets 112 are positioned far enough under the periphery of the underside 110 of the tabletop member 14 so that the accessory holding pockets 112 are not hit by objects on or near the tabletop member 14. The accessory holding pockets 112 are protected by the tabletop member 14. The accessory holding pockets 112 are adapted to hold any useful items where it would be desirable to keep the items off the upper surface 22 of the tabletop member 14. Some examples of such items might include nails, screws, masking tape or any number of other useful items. The easy on and easy off nature of the accessory holding pockets 112 will be discussed in greater detail with regard to FIGS. 10, 11, and 12. The accessory holding pockets 112 shown are in the form of small drawers 114 that pull out under the tabletop member 14, but it is within the spirit and scope of the invention that the accessory holding pockets 112 could be in other forms such as sacks or boxes.

FIG. 4 is a bottom view of the portable work table attachment 10 of the present invention. On the lower surface 114 of the tabletop member 14 there are two horizontal guides 116 and 118 that are adapted to fit just outside the outer periphery 120 of the front 122 and back 124 of the hopper 74 of the wheelbarrow 28, as seen most clearly in FIG. 6. Two vertical strips 126 and 128, which are adapted to fit just outside the outer periphery 130 of the first 132 and second 134 sides of the hopper 74, as seen most clearly in FIG. 6, separate and are attached to the two horizontal guides 116 and 118. The door 24 is positioned between the horizontal guides 116 and 118 and vertical strips 126 and 128 and near the back 124 of the hopper 74 closest to the handle portion 104 of the wheelbarrow 28, as seen also most clearly in FIGS. 4 and 6. The two horizontal guides 116 and 118 and the two vertical strips 126 and 128 form a retainer 136 that keeps the portable work table attachment 12 from moving around in its position atop the wheelbarrow 28. The retainer 136 can be in any form that accomplishes this objective and while the retainer 136 is attached to the lower surface 114 of the portable work table attachment 12, it is also within the spirit and scope of the present invention that the retainer 136 be adjustably attached to the lower surface 114 of the portable work table attachment 12.

In the first preferred embodiment of the present invention the tabletop member 14 extends out past the front 122 of the hopper 74 by a substantial amount, as seen most clearly in FIG. 3, but it is within the spirit and scope of the invention to make the tabletop member 14 generally proximate to the front 122 of the hopper 74, as seen most clearly in FIG. 17, as will be described in greater detail hereinafter. When the tabletop member 14 extends out past the front 122 of the hopper 74 by a substantial amount, as seen in FIG. 3, there is provided an extended horizontal member 123 to give added support to the tabletop member 14 as it extends out beyond the front 122 of the hopper 74. Also, in the first preferred embodiment of the present invention, the tabletop member 14 extends out past the sides 132 and 134 of the hopper 74, as seen in FIG. 6, by a substantial amount. But, it is also within the spirit and scope of the present invention that the tabletop member 14 has sides 138 and 140 that are also generally proximate to the sides 132 and 134 of the hopper 74, as seen in FIGS. 6 and 17. If it is desirable to have the tabletop member 14 elongated from front 142 to back 144, as seen in FIG. 3 but still have sides 138 and 140 that are proximate to the sides 132 and 134 of the hopper 74, as seen in FIGS. 6 and 17 as would be preferred for an indoor version of the portable work table attachment 14, so that the unit could easily fit through doorways that is also within the spirit and scope of the invention. Also, in the present invention the wheelbarrow table attachment system 10 is used on a six cubic yard wheelbarrow, but it is also within the spirit and scope of the invention to use the wheelbarrow table attachment system 10 with any size wheelbarrow and the retainer 136, as seen most clearly in FIG. 4, can be adjusted to accommodate any size top rim 86 of a wheelbarrow 28, as seen most clearly in FIGS. 6 and 21 and as will be described hereinafter.

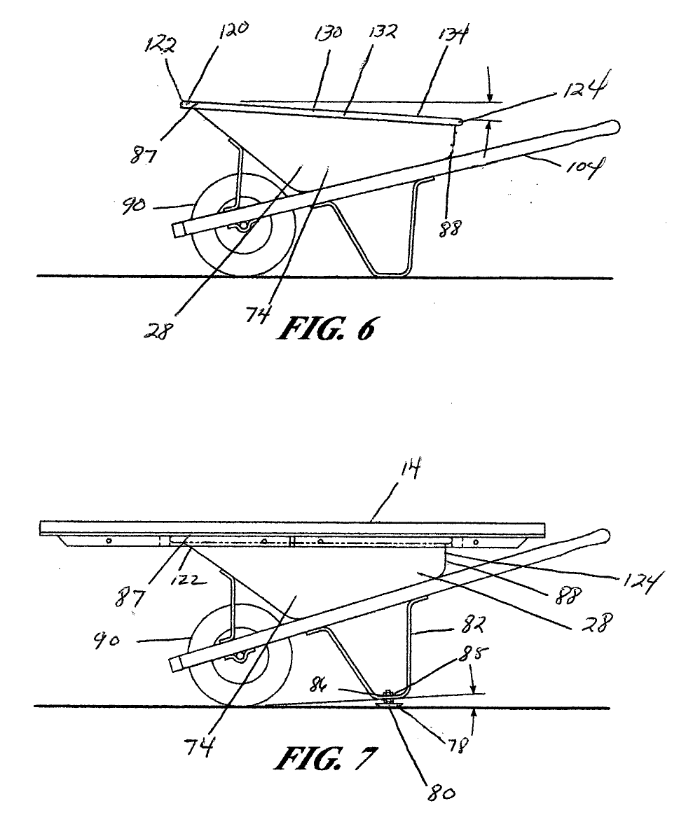

Referring now to FIG. 5, there is shown a top view of the portable work table attachment system for a wheelbarrow of the present invention. In FIG. 5, there is shown indicia 138 that is a measuring grid 140. It is also within the spirit and scope of the invention to include conversion table, weights and the like, that would be helpful to the user.

FIG. 6 is a side view showing how a wheelbarrow 28 is normally situated on level ground with the back 124 of the hopper 74 sloped downward from the front 122 of the hopper 74.

FIG. 7 is a side view of the portable work table attachment system 10 for a wheelbarrow 28 of the present invention showing the tabletop 14 leveled off when the wheelbarrow 28 is situated on level ground by means of the first preferred embodiment of leveler 80, as described hereinbefore.

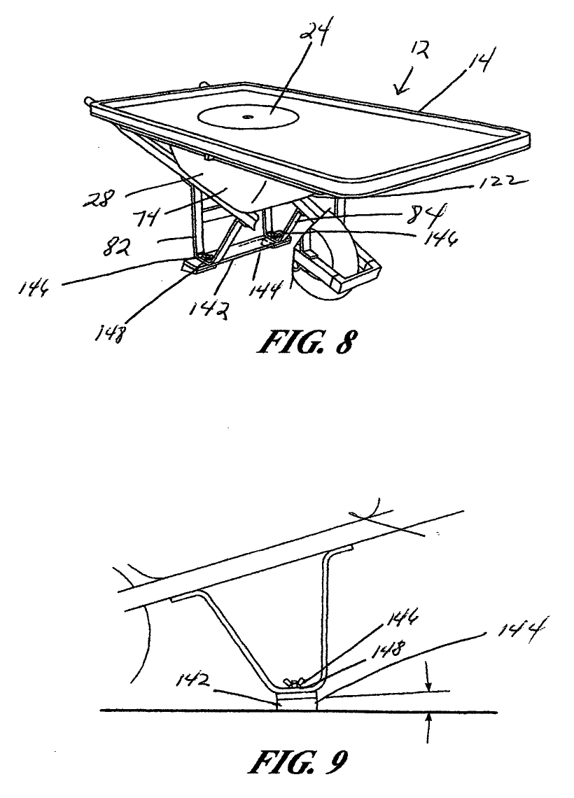

FIG. 8 is a three dimensional view of the portable work table attachment for a wheelbarrow of the present invention showing the tabletop leveled off when the wheelbarrow is situated on level ground, by means of the second preferred embodiment of stabilizer/leveler of the present invention. In FIG. 8 it can be seen that between the back legs 82 and 84 of the wheelbarrow 28 there is positioned planking 142 that is adapted to raise the back legs 82 and 84 of the wheelbarrow 28 so that the tabletop member 14 remains level from the back 124 of the hopper 74 of the wheelbarrow 28 to the front 122 of the hopper 74 of the wheelbarrow 28, as seen in FIG. 6, in a manner similar to that shown in FIGS. 6 and 7, but using the second preferred embodiment of stabilizer/leveler 144. It can be seen in FIG. 8 that the planking 142 that forms the second preferred embodiment of the stabilizer/leveler 144 extends the full length between the first rear leg 82 and the second rear leg 84 of the wheelbarrow 28. The stabilizer/leveler 144 of the second preferred embodiment is also adjustable in a manner similar to that described in reference to the leveler 80 of the first preferred embodiment. The planking 142 that forms the stabilizer/leveler 144 is also attached by a winged nut 146 through a hole 148 in the rear legs 82 and 84 of the wheelbarrow 28 in a manner similar to that described with reference to the leveler 80 of the first preferred embodiment.

FIG. 9 is a side view of the portable work table attachment system for a wheelbarrow of the present invention showing how the legs of the wheelbarrow are leveled with the front 122 of the hopper 74 of the wheelbarrow 28 using the second preferred embodiment of leveler 144, as seen in FIG. 8.

Referring now to FIGS. 10, 11 and 12 there is shown the accessory holding pockets 112 of the present invention. In FIG. 10 there is shown a side view of the portable work table attachment system for a wheelbarrow of the present invention showing the easy off nature of the accessory holding pockets 112. In FIG. 10 it can be seen that there are notch engaging buttons 150 positioned at predetermined intervals around the trim portion 152 under the periphery of the underside 110 of the tabletop member 14. If it is desired to remove a strip 154 of accessory holding pockets 112, the user moves the strip 154 to the left to disengage the buttons 150 from the notches 156 and pulls down to remove the strip 154 of accessory holding pockets 112.

FIG. 11 is a side view of the portable work table attachment for a wheelbarrow of the present invention showing the easy on nature of the accessory holding pockets 112. If it is desired to add a strip 154 of accessory holding pockets 112 the user positions the strip 154 of accessory holding pockets 112 with the notches 156 against the buttons 150 and moves the strip 154 to the right to lock the buttons 150 into the notches 156 and thereby securely attach the strip 154 of accessory holding pockets 112 to the trim portion 152 of the tabletop member 14.

FIG. 12 is a side view of the portable work table attachment system for a wheelbarrow of the present invention positioned atop a wheelbarrow with a plurality of accessory holding pockets 112 in place.

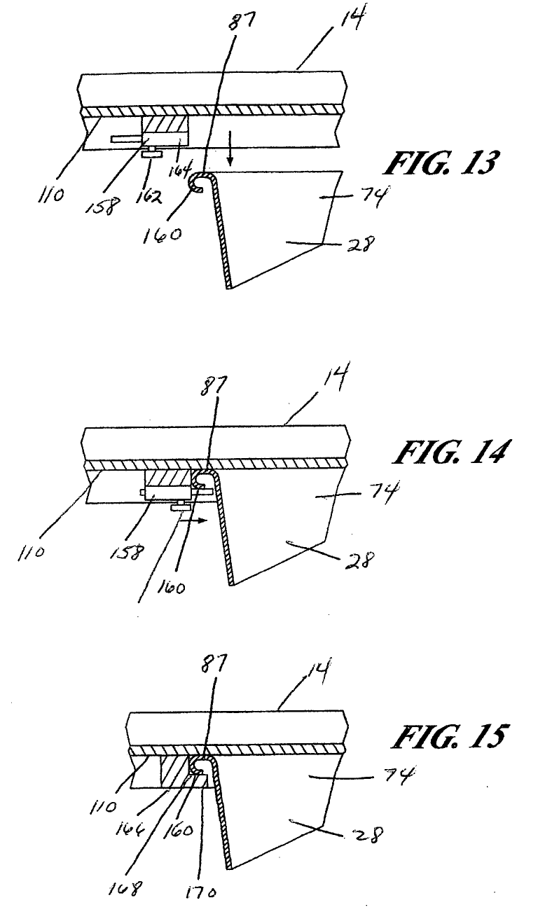

FIG. 13 is a side view of the portable work table attachment system for a wheelbarrow of the present invention showing how a spring loaded or hand tightened latch can be used to attach the tabletop to the rim of a wheelbarrow. FIG. 14 is a side view of the portable work table attachment system for a wheelbarrow of the present invention showing also how a different embodiment of a spring loaded or hand tightened latch can be used to attach the tabletop to the rim of a wheelbarrow. In FIG. 13 it can be seen that the tabletop member 14 has attached thereto at its underside 110 a spring loaded or hand tightened latch 158 whereby when the latch 158 comes into proximity with the outer rim 160 of the hopper 74 of the wheelbarrow 28, the tabletop member 14 is pushed downwardly whereby the latch 158 is engaged and either by spring loading or hand tightening a screw 162 is tightened under a key portion 164 of a latch 158 engaging the key portion 164 of the latch 158 to press against the outer rim 160 of the hopper 74 of the wheelbarrow 28.

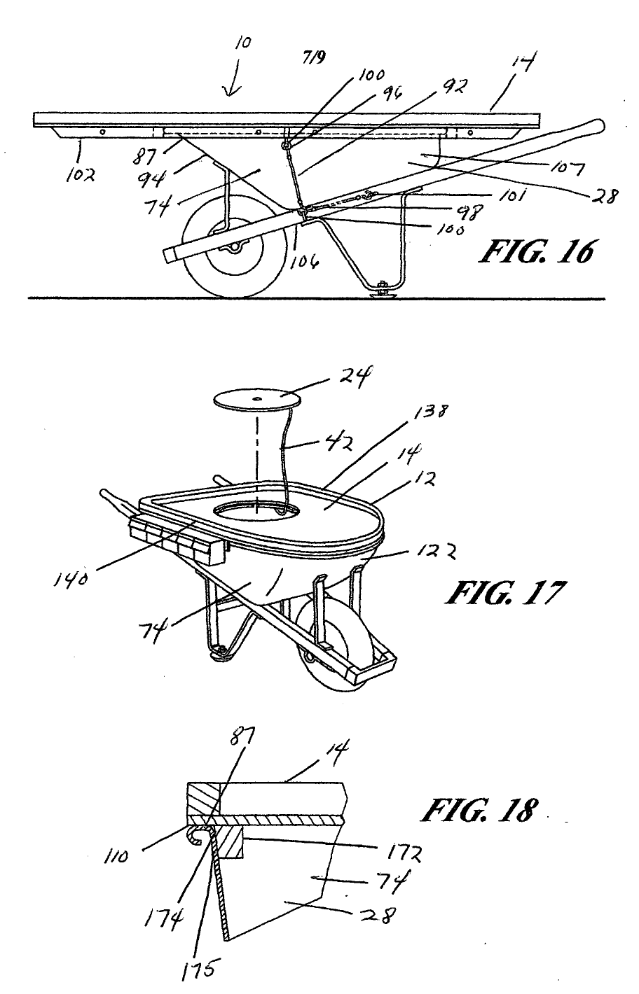

FIG. 15 is a side view of the portable work table attachment system for a wheelbarrow of the present invention showing how a cut out block can be used to click the tabletop onto the rim of a wheelbarrow. In FIG. 15 it can be seen that the tabletop member 14 has attached thereto at the underside 110 a cut out block 166 that is L-shaped. The cut out block 166 is adapted to receive the outer rim 160 of the hopper 74 of the wheelbarrow 28 within the inner portion 168 of the L-shape 170 to thereby hold the tabletop 14 tightly in place against the top rim 87 of the hopper 74 of the wheelbarrow 28.

FIG. 16 is a side elevation view showing the portable work table attachment system 10 for a wheelbarrow of the present invention and showing stretchable cording 92 attached between the tabletop 14 and the extended handle portion 106 of the wheelbarrow 28 to hold the tabletop 14 to the wheelbarrow 28 at each side 107 of the wheelbarrow 28, as described hereinbefore.

FIG. 17 shows a three dimensional view of a second preferred embodiment of the portable work table attachment for a wheelbarrow of the present invention shown with the door 24 open and showing a tabletop 14 that is adapted to fit in close proximity to the top rim 87 of the hopper 74 of the wheelbarrow 28. The second preferred embodiment as shown in FIG. 17 has been described hereinbefore in its various variations.

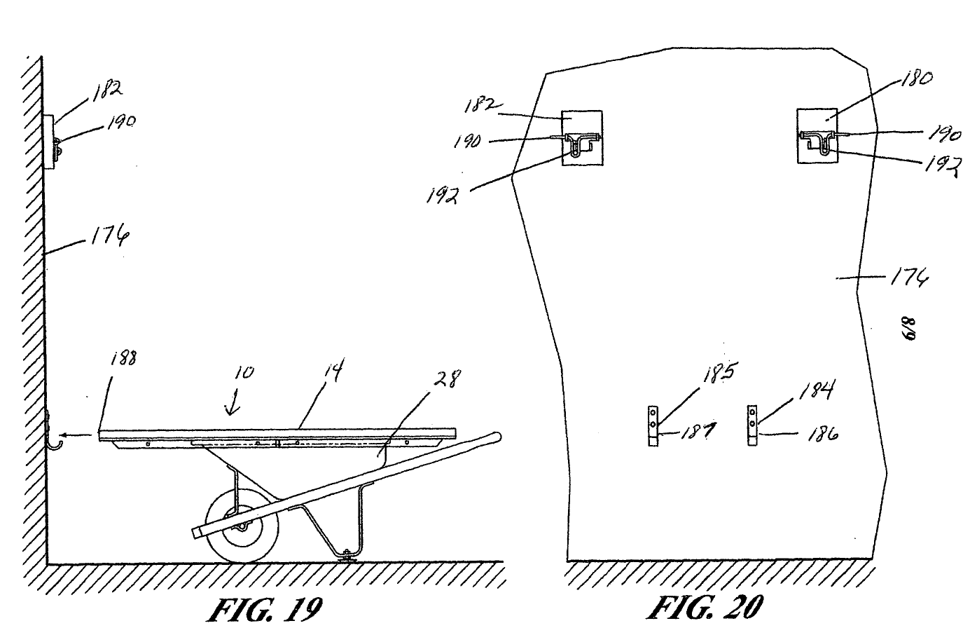

FIG. 18 is a side view of the portable work table attachment system for a wheelbarrow of the present invention as seen in FIG. 17 wherein a second type of cut out block 172 is attached to the underside 110 of the tabletop member 14 to attach the tabletop member 14 around the top rim 87 of the hopper 74 of the wheelbarrow 28. The tabletop member 14 as seen in FIG. 17, is attached to the top rim 87 of the hopper 74 of the wheelbarrow 28 by means of the second type of cut out block 172 being attached to the underside 110 of the tabletop member 14 in proximity to the top rim 87 of the hopper 74 of the wheelbarrow 28. As the tabletop member 14 is brought into engagement with the top rim 87 of the hopper 74 of the wheelbarrow 28, the second type of cut out block 172 snugs into the upper inside 174 of the hopper 74 to hold the tabletop member 14 tightly against the side 175 of the hopper 74 of the wheelbarrow 28. The stretchable cording 92, as seen in FIG. 16, can be used in combination with any of the cut out blocks or latches as shown and described with reference to FIGS. 13, 14, 15, or 18 to hold the tabletop 14 to the wheelbarrow 28 at each side 107 of the wheelbarrow 28.

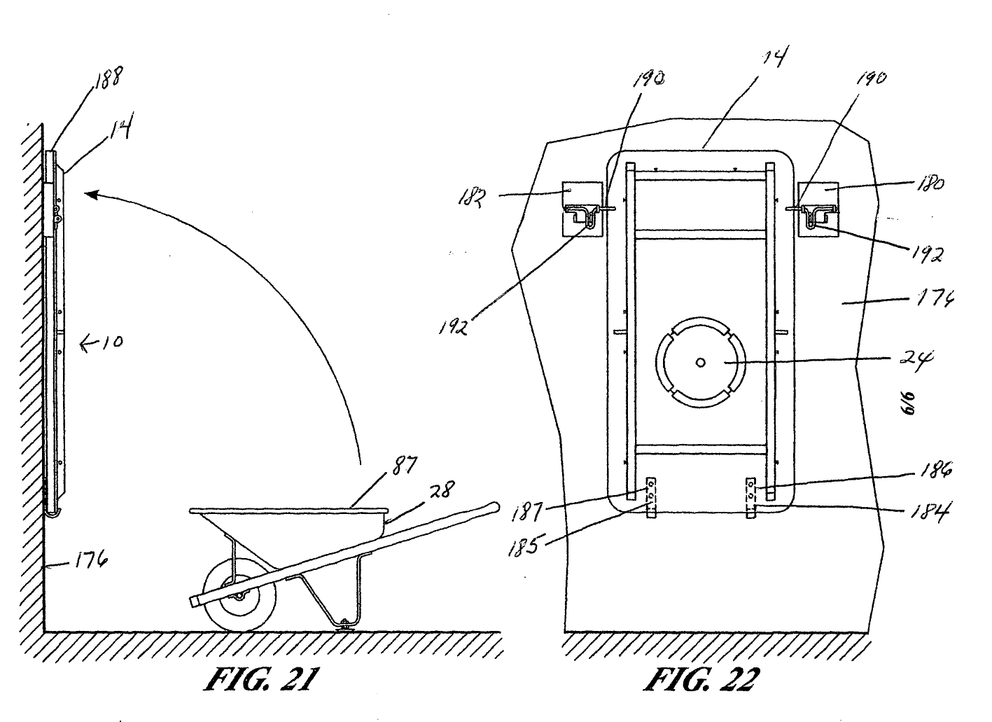

Referring now to FIGS. 19, 20, 21 and 22 there is shown in FIG. 19 a side view of the portable work table attachment system for a wheelbarrow showing how the tabletop member 14 is positioned to be attached to a wall 176 by means of an attacher 178. The attacher 178 includes two upper slides 180 and 182 that capture the tabletop member 14 tight to the wall 176 and can then be locked in place, and two lower hooks 184 and 185 in the form of brackets 186 and 187 placed at a height on the wall 176 whereby when the wheelbarrow 28 with the tabletop member 14 attached is pushed up against the wall 176 front end 188 first. The brackets 186 and 187 catch and capture the front end 188 of the tabletop member 14 as it is lifted and pivoted up and off of the wheelbarrow 28 and swung into locked position. Thus, it can be seen in FIGS. 19, 20, 21 and 22 in practice, when the user, is done using the portable work table attachment system 10 for a wheelbarrow of the present invention for a project, the wheelbarrow 28 is wheeled into a garage or other storage area having a wall 176. The wheelbarrow 28 is moved to the storage wall 176 and then pushed against the wall 176 front end 188 first. Then, as described earlier, the lower brackets 186 and 187, as seen in FIGS. 20 and 22, catch and capture the front end 188 of the tabletop member 14 and the tabletop member 14 is pushed against the two upper slides 180 and 182. When the tabletop member 14 is in place against the upper slides 180 and 182 the slide portion 190 of the slides 180 and 182 is moved inwardly across the tabletop member 14 holding it securely to the wall 176.

FIG. 21 is a side view of the tabletop member 14 as it would appear after it is attached to a wall 176 when the wheelbarrow table attachment system 10 is not in use. It can be seen in FIG. 21 that the tabletop member 14 is conveniently stored out of the way and flat against a wall 176, when the wheelbarrow table attachment 12 is not in use. Seen in FIG. 22 is the use of locks 192 attached to the two upper slides 180 and 182 to lock the tabletop member 14 in place to thereby prevent vandalism or other accidental dislocation of the tabletop member 14 from the wall 176.

A method for providing a portable work table attachment system for a wheelbarrow 10 is also disclosed whereby a tabletop member 14 is provided that has a door 24 positioned therein whereby when the door 24 is open there is formed an orifice 34 that holds tools 70 and other articles and when the door 24 is closed the upper surface 16 of the tabletop member 14 remains flat. Also provided is a an adjustable foot 78 that forms a leveler 80 attached under the two rear legs 82 and 84 of the wheelbarrow 28. In the alternative, planking 142 forms a leveler 144 for leveling the wheelbarrow 28 from the front 122 of the hopper 74 to the back 124 of the hopper 74 when the wheelbarrow 28 is situated on level ground. And, two pieces of stretchable cording 92 are provided which attach the underside 110 of the tabletop member 14 to the handle portion 30 of the wheelbarrow 28 to thereby tighten the tabletop member 14 to the wheelbarrow 28. In addition, there are provided a plurality of accessory holding pockets 112 removably attached around the periphery of the underside 110 of the tabletop member 14.

1. An attachment for a wheelbarrow, the wheelbarrow having an outer perimeter, a handle portion, a plurality of rear legs, and a hopper, the hopper having a top rim, a floor, and a first and second sides, the attachment comprising:
a portable work table, having an outer periphery, the work table fitting outside the outer perimeter of the top rim of the hopper of the wheelbarrow.

2. The attachment for a wheelbarrow as defined in claim 1 wherein the portable work table is removably attached to the outer perimeter of the wheelbarrow by means of a retainer.

3. The attachment for a wheelbarrow as defined in claim 1 wherein the tabletop has a front and the top rim of the hopper of the wheelbarrow has a front and wherein the front of the work table extends out from the front of the top rim of the hopper of the wheelbarrow.

4. The attachment for a wheelbarrow as defined in claim 1 wherein the tabletop has a front portion and the top rim of the hopper of the wheelbarrow has a front and wherein the front of the work table is proximate to the front of the top rim of the hopper of the wheelbarrow.

5. The attachment for a wheelbarrow as defined in claim 2 wherein the retainer comprises horizontal guides and vertical strips.

6. The attachment for a wheelbarrow as defined in claim 1 wherein the portable work table is a generally rectangular tabletop member.

7. The attachment for a wheelbarrow as defined in claim 1 further comprising:
a lip around the outer periphery of the portable work table to keep articles from rolling off the portable work table.

8. The attachment for a wheelbarrow as defined in claim 1 further comprising:
a containing orifice formed by a door in the portable work table and having the floor of the hopper as its floor and the first and second sides of the wheelbarrow hopper form the first and second sides of the orifice.

9. The attachment for a wheelbarrow as defined in claim 1 further comprising:
a plurality of accessory holding pockets removably attached around the outer periphery of the portable work table.

10. The attachment for a wheelbarrow as defined in claim 1 further comprising:
a leveler removably attached to at least two of the rear legs of the wheelbarrow for making the top rim of the hopper level when the wheelbarrow sits on level ground.

11. The attachment for a wheelbarrow as defined in claim 1 wherein the portable work table has sides and the front and sides of the tabletop are proximate to the front and sides of the hopper and the tabletop is generally squared at a first end and elliptical at a second end.

12. The attachment for a wheelbarrow as defined in claim 1 further comprising indicia for assisting a user, the indicia fixedly attached on the upper surface of the portable work table.

13. An attacher for an attachment for a wheelbarrow, the attachment having an upper part and a lower part, the attacher for attaching the attachment to a wall when the attachment is not in use, the attacher comprising:
a) a plurality of slides for capturing the upper part of the attachment;
b) a plurality of hooks for capturing the lower part of the attachment.

14. The attacher for an attachment for a wheelbarrow as defined in claim 13 wherein the hooks are brackets.

15. The attacher for an attachment for a wheelbarrow as defined in claim 13 further comprising:
locks attached to the slides for locking the attachment against the wall.

16. A method for providing an attachment for a wheelbarrow, the wheelbarrow having an outer perimeter, a handle portion, a plurality of rear legs, and a hopper, the hopper having a top rim, a floor, and a first and second sides, the method comprising:
providing a portable work table, having an outer perimeter, the work table fitting outside the outer perimeter of the top rim of the hopper of the wheelbarrow.

17. The method for providing an attachment for a wheelbarrow as defined in claim 16 wherein the portable work table is removably attached to the outer perimeter of the wheelbarrow by means of a retainer.

18. The method for providing an attachment for a wheelbarrow as defined in claim 16 wherein the tabletop has a front and the top rim of the hopper of the wheelbarrow has a front and wherein the front of the work table extends out from the front of the top rim of the hopper of the wheelbarrow.

19. The method for providing an attachment for a wheelbarrow as defined in claim 15 wherein the tabletop has a front portion and the top rim of the hopper of the wheelbarrow has a front and wherein the front of the work table is proximate to the front of the top rim of the hopper of the wheelbarrow.

20. The method for providing an attachment for a wheelbarrow as defined in claim 17 wherein the retainer comprises horizontal guides and vertical strips.
